(19) United States
(12) Patent Application Publication
(10) Pub. No.: US 2024/0403747 A1
(43) Pub. Date: Dec. 5, 2024

(54) SOCIAL RESPONSIBILITY LOAD BALANCER

(71) Applicant: Wells Fargo Bank, N.A., San Francisco, CA (US)

(72) Inventors: Carrie Anne Hanson, Charlotte, NC (US); Stacey Anne Howard, Amherst, NH (US); Julio Jiron, San Bruno, CA (US); Muhammad Farukh Munir, Pittsburg, CA (US); Benjamin S Taylor, Williston, VT (US)

(73) Assignee: Wells Fargo Bank, N.A., San Francisco, CA (US)

(21) Appl. No.: 18/205,731

(22) Filed: Jun. 5, 2023

(51) Int. Cl. G06Q 10/0631

(52) U.S. Cl. CPC G06Q 10/06311

(57) ABSTRACT

Systems and techniques for social responsibility load balancer are described herein. First user data for a first user and second user data for a second user is obtained. The first user data is aggregated into a first dataset and the second user data is aggregated into a second dataset. The first dataset and the second dataset are evaluated using a responsibility prediction learning model to determine a set of responsibilities. A target responsibility delta is calculated. The set of responsibilities are processed using a responsibility balancing algorithm to sort the set of responsibilities into the first responsibility assignments and the second responsibility assignments. A current delta is calculated between the first responsibility assignments and the second responsibility assignments. It is determined that the current delta is equal to the target responsibility delta. A user interface is generated to output the first responsibility assignments and the second responsibility assignments.

### TECHNICAL FIELD

Embodiments described herein generally relate to resource allocation and, in some embodiments, more specifically to a load balancer for cooperative balancing of financial and non-financial workloads.

### BACKGROUND

Cohabitating couples may include persons that share a residence or responsibilities that may not have a legal relationship status (e.g., married, etc.). Cohabitating couples may share financial and social obligations (e.g., chores, etc.). Cohabitating couples tend to have one-third the net worth of married couples. The reduced net worth may be attributed to a lack of shared financial goals and lack of finance and obligation division that may be simplified by the legal benefits of a legal relationship status. Individuals with a legal relationship status may also find that there are disparities (e.g., inequalities, etc.) in the division of financial and social responsibilities by the parties of the relationship.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for social responsibility load balancer, according to an embodiment.

FIG. 2 illustrates an example machine learning component for resource selection for a social responsibility load balancer, according to an embodiment.

FIG. 3 illustrates an example of a process for a social responsibility load balancer, according to an embodiment.

FIG. 4 illustrates an example of a method for a social responsibility load balancer, according to an embodiment.

FIG. 5 is a block diagram illustrating an example of a machine upon which one or more embodiments may be implemented.

### DETAILED DESCRIPTION

Cohabitating couples tend to have one-third the net worth of married couples. Some couples may spend more time trying to keep assets separate than they would spend if they managed finances cooperatively. Cohabitating couples may find a template for maximizing net worth helpful in setting financial goals and evenly distributing financial and non-financial responsibilities. Couples with a legal relationship status may also benefit from balancing financial and non-financial responsibilities to address inequalities in the division of responsibilities.

The systems and techniques discussed herein provide resources to cohabitating couples regardless of legal relationship status. Cohabitating couples may have fewer options than married couples, while also having tax burdens of single people. An artificial intelligence (AI) profiler is used to generate and present advice on investment, tax filings, combined or separating finances, etc. to cohabitating couples. Couples that may have a legal status may be presented with options regarding how much financial life to share (e.g., entirely joint accounts, entirely separate finances, or somewhere in between). The profiler may help couples be more intentional in making financial decisions.

An AI model may be generated for a profiler that includes features for evaluating tax implications of various recommended financial responsibility modification. The AI model may be customized based on goals of the users and the users may be presented with a comparison view that shows their current financial path and what a financial path may look like with selected modifications. The profiler identifies a current group type and a target group type that would result in a maximized balanced output based on inputs received including user provided constraints and identified responsibilities.

For example, a user and another user may agree to provide account information that may be used to collect input data for the profiler. The profiler calculates a valuation without sharing all user account details. The output may include data that is shared between the users to determine if the division of responsibilities is fair to the users. Recommendations are generated and output that provide money management suggestions for maximizing a financial path. For example, the recommendations may reduce a tax burden, increase money available for achieving a savings goal, reducing spending by eliminating duplicative recurring charges, etc.

The AI model may determine whether the users should separate or combine finances, output advice regarding activities that should be performed, and for users with separate finances, evaluate whether the current division of responsibilities treats one user fairly without providing detail about finances of the other user. For example, a recommendation may be generated that suggests a user pay more this month because the other user has paid more recently or taken care of more non-financial responsibilities (e.g., household responsibilities, etc.) recently. Thus, the profiler may evaluate financial and non-financial obligations such as, by way of example and not limitation, how much a user takes care of children. The profiler presents a current financial path and a future recommended financial path that maximizes accounts of the users to create a common understanding of the distribution of responsibilities between the users. Financial aggregation is competed at an individual level for each user. The aggregated financial data for each user is evaluated to identify opportunities for duplication (e.g., do both users pay for a subscription service that could be shared, etc.). This enables users to move away from individual goals to shared goals (e.g., from separate savings goals to household combined savings goals, etc.).

The profiler may use modular AI models that may include models for financial equity, work equity, health, investment strategies, etc. and the users may select the modules to be enabled when evaluating the input data to generate output recommendations. A feedback loop may be used to continually evaluate data including adjustments to refine AI models to increase prediction accuracy.

Adjustments may be made by the profiler for incomes, domestic work, etc. The adjustments may be based on a user provided scale, chore chart, etc. or may be automatically generated by the profiler based on similarly situated (e.g., having similar attributes, etc.) couples. The profiler may make automatic dynamic adjustments for life events (e.g., loss of employment by a user, etc.). An interface may be provided to the users for negotiating responsibility swaps, etc.

Transactions are tracked for spending categories including, by way of example and not limitation, school expenses, activities for children, groceries, etc. Transactional data may be collected from records of a monetary account as direct input and machine learning may be used to line up tasks and assign values based on value analysis. Data may be imported from different accounts and containers may be created for each account. The users are presented with their current contribution levels and a delta between the individual contributions of the users. The profiler may send a notification when financial anomalies are detected in the transactional data. Financial anomalies may include transactions that were not expected based on a financial path for a user, transactions that appear to be fraudulent, duplicate expenses, etc.

The profiler output may be used in a variety of contexts such as prenuptial agreements, as a tool in marriage counseling whereby if one of the users still feels that the distribution of responsibilities is not fair the users may seek counseling and additional recommendations may be provided based on inputs from the counseling. The profiler may be used in households with more than two persons that may include family members such as children, parents, grandparents, etc. This may be helpful in managing multigenerational households where there are multiple persons making contributions and having responsibilities to the household. The profiler output may be provided to a lender by a borrower to provide access to a snapshot of financials. Historical progression of a path may be stored to generate a life story across generations to see the impact of financial decisions as an education tool for new generations. The history may track contribution and maintain a track record of performance of the path. A central storage location may be provided as a central location for end-of-life docs.

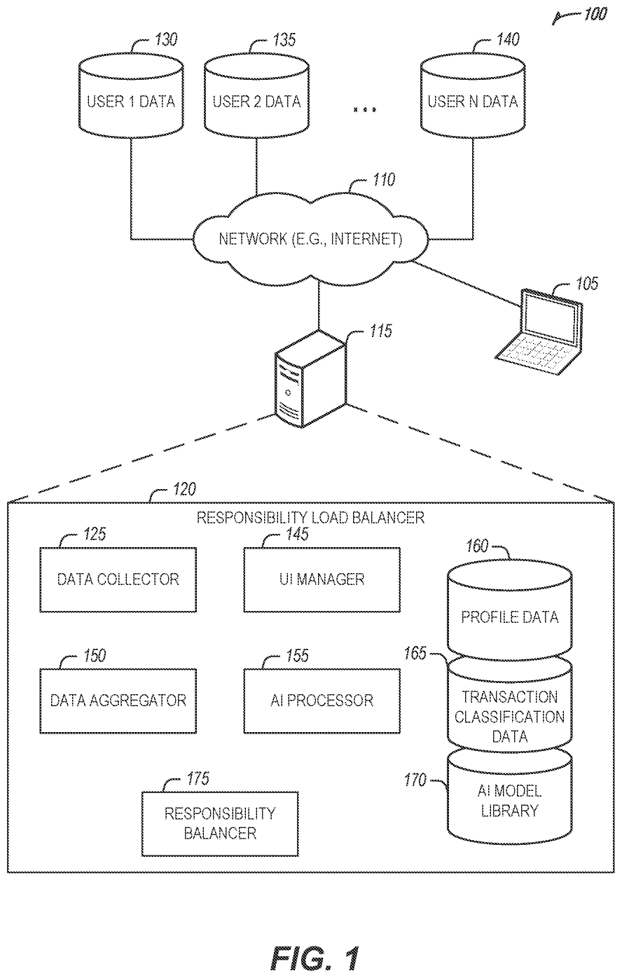

FIG. 1 is a block diagram of an example of an environment 100 and a system 120 for social responsibility load balancer, according to an embodiment. The environment 100 may include a user computing device 105 (e.g., a desktop computing device, a laptop computing device, a mobile computing device, a tablet computing device, a smartphone, etc.) communicatively coupled to a server computing device 115 (e.g., a standalone server, a cluster of servers, a cloud computing platform, a virtual machine, etc.) via a network 110 (e.g., the Internet, a wireless network, a wired network, a cellular network, a satellite network, etc.).

The server computing device 115 may include (e.g., in dedicated hardware, implemented in software installed on non-transitory machine-readable media that is executed by at least one processor, etc.) the system 120. In an example, the system 120 is a responsibility load balancer. The system 120 may include a variety of components including a data collector 125, a user interface (UI) manager 145, a data aggregator 150, an artificial intelligence processor 155, profile data 160, transaction classification data 165, an AI model library 170, and a responsibility balancer 175.

The UI manager 145 generates user interfaces to be transmitted to a user to receive inputs and display outputs. The UI manager may generate a registration user interface that is output to the user computing device 105. The registration user interface may include a variety of prompts and controls that enable the user to provide authorization to access user data (e.g., user 1 data 130, user 2 data 135, or user N data 140) that includes financial account data, activity data, etc. Multiple users may be presented with the registration user interface via the user computing device 105 or another computing device. Each user authorizes access to their respective user data by providing account information (e.g., online account access information, username, password, authentication token, etc.). In an example, the registration user interface may include access level controls that the user may activate to provide access permission levels (e.g., all data, a subset of data, a time period of data, etc.) for access to the data of the user.

The data collector 125 receives the account information and access level authorization input by the user. The data collector 125 includes authentication mechanisms (e.g., password-based, multi-factor, biometric, single sign-on, token-based, certificate-based, etc.) and access mechanisms (e.g., application programming interface (API) calls, database connectors, etc.) for accessing data sources provided by the user and obtaining data from the data sources. For example, the user may select an online banking service in the registration user interface and may input a username and password for the online banking service. The data collector 125 may use an API call to access the online banking service and may authenticate with the online banking service using the user provided username and password. The data collector 125 may obtain financial transaction data (e.g., withdrawals, deposits, debits, credits, etc.) from the online banking service.

The data aggregator 150 receives the user data and aggregates the data to generate an aggregated data set. In an example, transactions may be aggregated based on classification of the transactions (e.g., by time period, merchant type, expense category, etc.) using transaction classification data 165. The transaction classification data 165 may include rules for classification of transactions. For example, classifications may include categories for, by way of example and not limitation, dining, travel, childcare, entertainment, fuel, and the like. The transaction classification data 165 may include tables of merchants that have a designated category or may include sets of rules for determining one or more categories to assign to a merchant that is associated with a transaction. In an example, if a category cannot be automatically determined for a transaction, the data aggregator 150 may work in conjunction with the UI manager 145 to generate a user interface to be displayed to the user computing device 105 to prompt the user to select a category for the transaction. The selection of the user is stored in the transaction classification data 165 so that the transaction is automatically classified in the future. The data aggregator 150 may further aggregate the individually aggregated data sets to generate a summary aggregation for the responsibility information for two or more users.

The UI manager 145 generates a configuration user interface for transmission to the user computing device 105 that enable the user to select objectives (e.g., financial balancing, non-financial balancing, goal setting, education, etc.) with which the user desires to the system 120 to assist. The AI processor 155 receives the selected objectives and selects corresponding AI models from the AI model library 170. The AI model library 170 includes a variety of purpose trained learning models that have been trained by the AI processor 155 using a corpus of training data. For example, the AI model library 170 may include models for predicting duplicate expenses in user data, for predicting tax burdens of expenses attributed to one or more users, for predicting a monetary value of a non-monetary responsibility (e.g., childcare, household tasks, etc.), for predicting whether a current allocation will achieve a future goal, and the like.

The configuration user interface may include controls for setting user preferences (e.g., allocation scales, weights for tasks or responsibilities, income, etc.). The user may be able to input responsibilities that may not be identifiable from the user data. For example, household tasks may not be reflected in the user data and the user may be presented with a data entry view to enter the household tasks. The user may be able to assign a value (e.g., monetary value, time value, relative value score, etc.) to the non-monetary responsibilities. In an example, the AI processor 155 may select a non-monetary responsibility valuation model from the AI model library 170 and may evaluate the list of non-monetary responsibilities to predict values for each responsibility automatically. The user preferences, the manually provided responsibility data, and the manually and automatically assigned values are stored in the profile data 160. The responsibility balancer 175 may work in conjunction with the AI processor 155 to generate a detailed summary of a current responsibility of the users and to generate a responsibility assignments for the users based on the user data of the users and the preferences provided by the users. For example, the AI processor 165 may generate a list of categorized transactions and non-monetary responsibilities for each user that may be displayed in a user interface generated by the UI manager 145. The list of categorized transactions enable the users to see a current distribution of responsibilities amongst the users.

The AI processor 155 may generate the AI models in the AI model library 170 by receiving a corpus of training data that may be labeled or unlabeled and may establish the models to include algorithms that classify and take actions on data based on rules observed in the training data and generated as algorithms in the AI model. As previously discussed, the AI model library 170 may include a variety of purpose built AI models that may be stored as modules that may be enabled by a user for use by the AI processor 170. For example, the AI models may include, by way of example and not limitation, a financial data classification model, a non-monetary responsibility valuation model, a responsibility balancing model, a goal achievement prediction model, etc. The responsibility balancer 175 may work in conjunction with the AI model to evaluate user data using the responsibility balancing model. For example, the responsibility balancing model may receive responsibilities (financial and non-financial) from the data aggregator 150 and the user preferences from the profile data 160 as inputs and may generate the responsibility assignments as an output. In an example, the responsibility balancer 175 (or the AI processor 155) may execute an iterative responsibility balancing algorithm that may move responsibilities between the parties until it is determined that the assignment of responsibilities can no longer be optimized to reduce the delta between the responsibilities (e.g., delta approaching zero, delta approaching a scale or differential provided in the profile data 150, etc.).

The UI manager 145 generates a recommended responsibility assignment user interface for display by the user computing device 105. The user interface may include controls for exporting printing, or otherwise converting the responsibility assignments to another form. In an example, the use interface may include controls that allow the user to swap, exchange, or otherwise alter the recommended assignments. The user may be provided with additional recommendations based on the changes. For example, a first user may select a lawn mowing task be reassigned from a second user to the first user and a recommendation may be presented to reassign a streaming service expense payment from the first user to the second user. Thus, the users are able to make assignment changes based on preferences not previously expressed while maintain balance in the assignments.

The responsibility assignments and financial data of the users may be stored in the profile data 160 and used to create historical or trend reports that enable the users to identify if they are on track to meet a designated goal, if they have improved their financial outlook, etc. In an example, the users may be able to upload important documents (e.g., wills, living wills, powers of attorney, healthcare directives, insurance policy documents, deeds, other legal documents, etc.) to their profile via an upload user interface generated by the UI manager 145. The upload allows the users to maintain a central storage location for important documents. In an example, the users may be presented with a beneficiary user interface that allows the users to grant access to a third-party (e.g., family member, executor, etc.) to view and download documents (e.g., upon incapacitation, death, at a designated time, etc.).

The responsibility manager 175 may occasionally (e.g., at a designated interval, annually, quarterly, on-demand, etc.) reevaluate the user data to determine if the prior responsibility assignments are still accurate (e.g., do they continue to minimize the responsibility delta, etc.) for the current responsibilities of the users. In an example, account data of the users may be obtained quarterly and the data may be evaluated by the AI processor 155 on behalf of the responsibility balancer 175. The responsibility balancer 175 may determine a responsibility matrix for the users based on the currently obtained data and may compare the responsibility matrix to the current responsibility assignments to identify adjustments that could be made. The users may be sent a notification of the adjustments that allows them to accept or reject the adjustment. For example, new financial or non-financial responsibilities may be provided or identified that have led to an imbalance in the responsibilities of the users. The responsibility manager 175 may generate a new responsibility assignment for the users to minimize the delta. In some examples, a life event may be detected in the user data. For example, deposits for one user may have ceased in a financial account and it may be predicted, by the AI processor 155 using a life event prediction model from the AI model library 170, that the user has lost a job. The responsibility balancer 175 may generate a temporary responsibility assignment for the users based on the life event of loss of a job and may output the temporary responsibility assignment to the user computing device 105. In an example, the AI processor 155 may classify expenses as necessary and discretionary and may evaluate the user data to identify expenses that could be pause or eliminated while the lost job condition persists. The identified expenses may be output to the user computing device 105 to enable the users to determine effective cost cutting opportunities. In an example, other life events may be identified such as, by way of example and not limitation, empty nest life stage detection based on child expenses ceasing, retirement stage based on identification of deposits from a government agency, etc. Changes to the responsibility assignments and other recommendations may be generated based on identification of the life events and presented to the users.

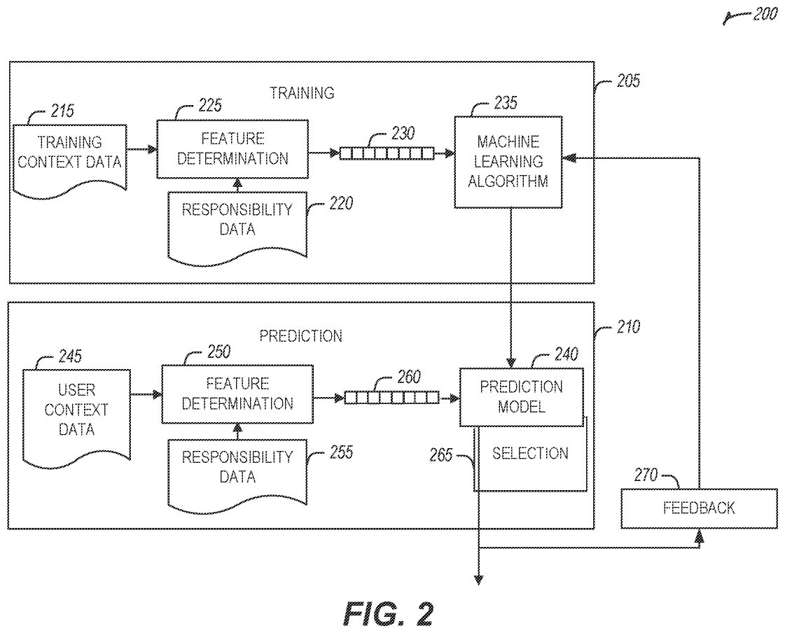

FIG. 2 illustrates an example machine learning component 200 for a social responsibility load balancer, according to an embodiment. The machine learning component 200 may be used by the AI processor 155 as described in FIG. 1. The machine learning component utilizes a training module 205 and a prediction module 210. Training module 205 feeds training context data 215 and responsibility data 220 into feature determination module 225 which determines one or more features 230 from this information. Features 230 are a subset of the information input and is information determined to be predictive of context relevant for a prediction based on the responsibility data 220. Examples include one or more of: transactions, non-monetary responsibilities, previous responsibility assignments, expense categories, life events, etc.

The machine learning algorithm 235 produces a prediction model 240 based upon the features and feedback associated with those features. For example, the features associated with responsibility assignment choices of users relating to the context are used as a set of training data. As noted above, the resource selection model 240 may be for the entire system (e.g., built of training data accumulated throughout the entire system, regardless of the user for which a resource is being selected), or may be built specific for each user account.

In the prediction module 210, the current user context data 245 may be input to the feature determination module 250. Similarly the user data 255 is also input to the feature determination module 250. Feature determination module 250 may determine the same set of features or a different set of features as feature determination module 225. In some examples, feature determination module 250 and 225 are the same module. Feature determination module 250 produces features 260, which are input into the prediction model 240 to perform output selection 265. The training module 205 may operate in an offline manner to train the resource selection model 240. The prediction module 210, however, may be designed to operate in an online manner as each user context is evaluated as location-based events occur.

It should be noted that the prediction model 240 may be periodically updated via additional training and/or user feedback. The user feedback may be feedback from users that provide explicit feedback (e.g., changes in responsibility assignments made by the users, etc.) or may be automated feedback based on outcomes of the selected resources provided to the user. For example, a user receiving a suggested responsibility assignment may provide an explicit response indicating a preference for an alternate resource assignment and the response may be used as additional training data for updating the prediction model 240. In an example, a context profile may be generated for the user that is stored in a user data store (e.g., the profile data 160, etc.). The stored context profile may be periodically updated as the context of the user changes (e.g., income changes, employment status changes, etc.). The stored context profile may reduce processing of user context data by providing a baseline user context that may be enhanced based on current user context. The baseline or enhanced context data may be evaluated using the resource selection model to predict relevant resources.

The machine learning algorithm 235 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, and hidden Markov models. Examples of unsupervised learning algorithms include expectation-maximization algorithms, vector quantization, and information bottleneck method. In an example embodiment, a multi-class logistical regression model is used.

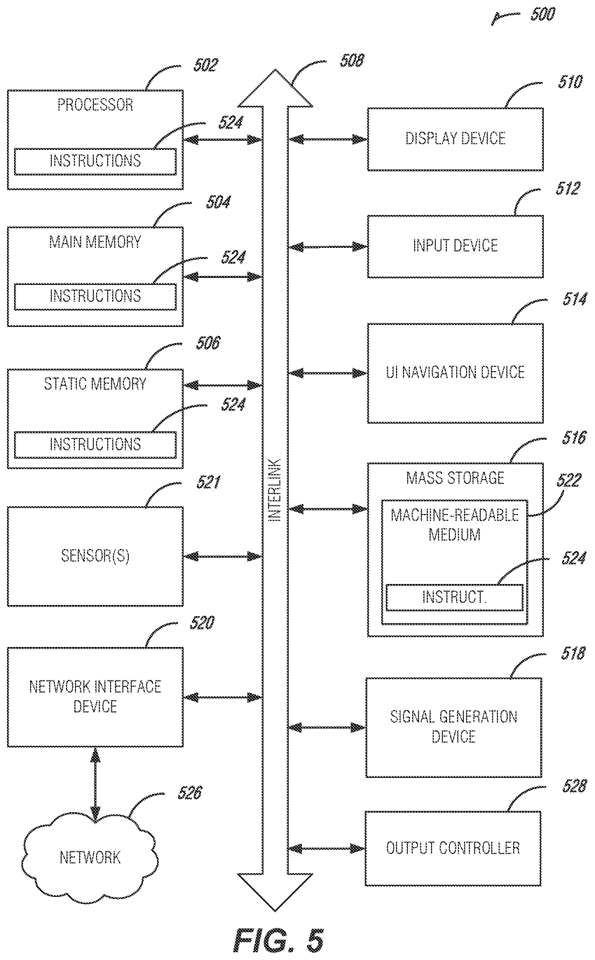

The system 120 as described in FIG. 1 and the machine learning component 200 may be implemented on one or more computing devices, such as machine 500 of FIG. 5. As such, some of the components of FIG. 1 may communicate with each other via inter-process communication and other local communications techniques (e.g., shared memory, pipes, buffers, queues). In other examples, the components of FIG. 1 may be parts of different services or systems and thus the components may communicate with each other through a computer network using computer networking protocols.

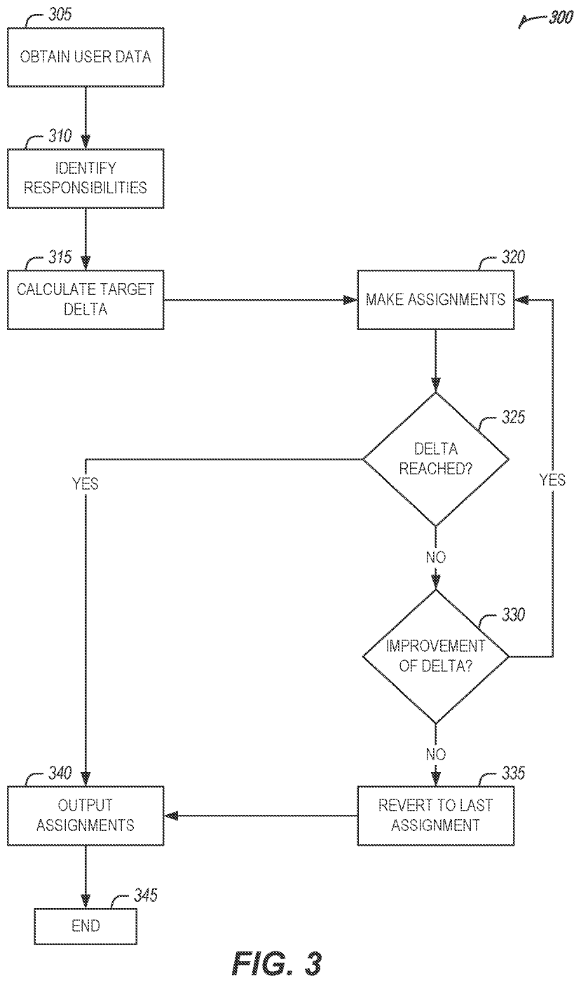

FIG. 3 illustrates an example of a process 300 for a social responsibility load balancer, according to an embodiment. The process 300 may provide features as described in FIGS. 1 and 2.

At operation 305, user data is obtained (e.g., by the data collector 125 as described in FIG. 1, etc.) for two or more users. The user data may be obtained from input data received from the user and from external or internal data sources that the user has identified and granted permission to electronically access the data sources. The user data may include financial transaction data and data regarding non-monetary responsibilities of the users.

At operation 310, responsibilities are identified (e.g., by the responsibility balancer 175 and the AI processor 155 as described in FIG. 1, etc.) using the user data. For example, transaction data may be evaluated to identify financial responsibilities from the financial data included in the user data and non-monetary responsibilities may be identified using input data from the users or by evaluating financial or non-financial data sources to determine a probability that the users relationship includes a non-monetary responsibility. For example, expenses related to children may be present in the financial data without a corresponding childcare expense and it may be determined that a childcare responsibility exists for the users.

At operation 315, a target delta may be calculated (e.g., by the responsibility balancer 175, etc.) for the users. The target delta represents a differential (e.g., in terms of time, monetary value, non-monetary value, etc.) between responsibility assignments of the users. If the users have not selected a scale or other adjustment value, the target delta is set to zero meaning that both users will be assigned equal responsibilities. If the users have provided a scale of other adjustment value, the target delta is set to a fraction (e.g., a percentage, etc.) that indicates an inequality assigned to one of the users. Thus, one user will have more responsibility assignments than the other user. For example, a first user may have a twenty percent higher income and a second user and the users may have set a twenty percent adjustment to financial responsibilities of the first user so that the first user is assigned financial responsibilities with a sum that is twenty percent higher than a sum of assigned financial responsibilities of the second user.

At operation 320, initial responsibility assignments are made (e.g., by the responsibility balancer 175, etc.). The initial responsibility assignments may use a sorting algorithm to make the initial assignments. At decision 325, it is determined if the initial responsibility assignments reach the target delta. For example, does the value of the assignments for the second user divided by the value of the assignments for the first user equal eighty percent? If not, it is determined if the responsibility assignment has improved or is closer to approaching the target delta at decision 330. This will be true for the initial responsibility assignment because there is no previous delta to compare. If the delta is improved, assignments are adjusted using a refinement algorithm at operation 320. It is again determined if the delta has been reached at decision 325. If not, refinement continues until the delta is reached (as determined at decision 325) or no further improvement is possible (as determined at decision 330). If the delta is reached, the responsibility assignments are output (e.g., by the UI manager 145 as described in FIG. 1, etc.) at operation 340. If it is determined that the delta was not met and the current responsibility assignment did not improve the delta, the responsibility assignments revert to the previous assignments and the responsibility assignments are output at operation 340. The process ends at 345.

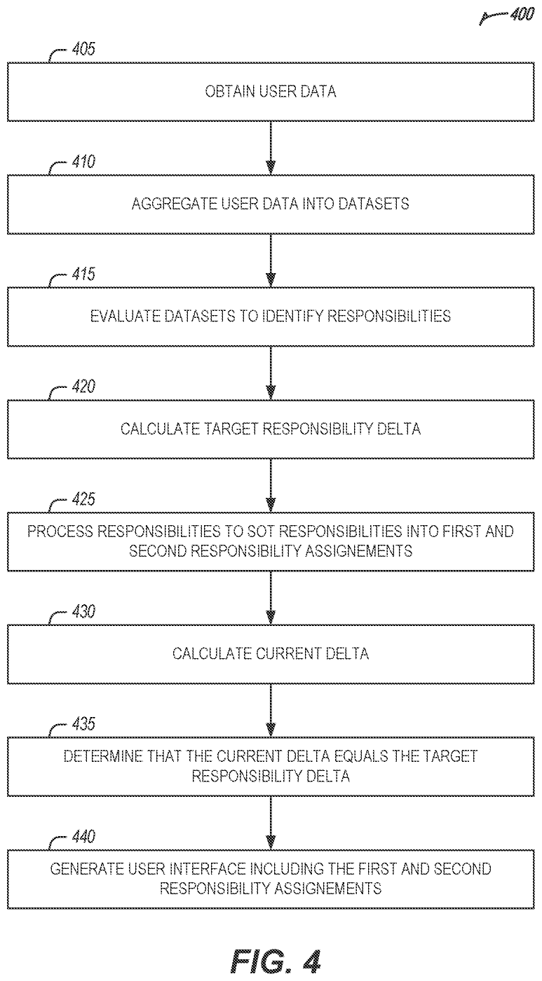

FIG. 4 illustrates an example of a method 400 for a social responsibility load balancer, according to an embodiment. The method 400 may provide features as described in FIGS. 1 to 3.

At operation 405, first user data for a first user and second user data for a second user is obtained (e.g., by the data collector 125 as described in FIG. 1, etc.). In an example, the first user data and/or the second user data may be obtained from an external data source. In an example, the first user data and/or the second user data may be obtained from user profile data (e.g., the profile data 160 as described in FIG. 1, etc.) of the first user or the second user respectively.

At operation 410, the first user data is aggregated (e.g., by the data aggregator 150 as described in FIG. 1, etc.) into a first dataset and the second user data is aggregated into a second dataset. In an example, the first dataset and the second dataset may be aggregated to create a composite dataset for the first user and the second user combined.

At operation 415, the first dataset and the second dataset are evaluated (e.g., by the AI processor 155 as described in FIG. 1, etc.) using a responsibility prediction learning model (e.g., from the AI model library 170 as described in FIG. 1, etc.) to determine a set of responsibilities. In an example, the responsibility prediction learning model may be trained by inputting a corpus of responsibility data and a corpus of user data into an artificial intelligence processor, extracting responsibility features from the responsibility data and the user data, and processing the responsibility features using a machine learning algorithm to generate the responsibility prediction learning model.

At operation 420, a target responsibility delta is calculated (e.g., by the responsibility balancer 175 as described in FIG. 1, etc.) between first responsibility assignments for the first user and second responsibility assignments for the second user. In an example, a delta scale may be obtained from a profile of the first user or the second user. A delta value offset may be determined using the delta scale and the delta value offset is applied to a standard delta value to calculate the target responsibility delta. In an example, a life event may be identified as output from an evaluation of the first dataset and the second dataset using a life event prediction learning model. A delta adjustment factor may be calculated based on the life event and the delta adjustment may be applied to the target responsibility delta. In an example, the first dataset and the second dataset may be evaluated using a duplicate expense prediction learning model to identify a duplicate expense and the duplicate expense may be output to the user interface.

At operation 425, the set of responsibilities are processed (e.g., by the responsibility balancer 175, the AI processor 155, etc.) using a responsibility balancing algorithm to sort the set of responsibilities into the first responsibility assignments and the second responsibility assignments. In an example, the set of responsibilities may be iteratively sorted into the first responsibility assignments and the second responsibility assignments. An iterative delta may be calculated for an iterative sort of the set of responsibilities into the first responsibility assignments and the second responsibility assignments. The iterative delta may be compared to a previous delta. It may be determined that the iterative delta is closer to the target responsibility delta than the previous delta and another iterative sort may be performed of the set of responsibilities into the first responsibility assignments and the second responsibility assignments. In an example, it may be determined that the iterative delta is not closer to the target responsibility delta than the previous delta. The previous delta may be set as the current delta. A difference may be calculated between the previous delta and the target responsibility delta. The target responsibility delta may be adjusted to the previous delta and the difference may be output in the user interface.

At operation 430, a current delta is calculated (e.g., by the responsibility balancer 175, etc.) between the first responsibility assignments and the second responsibility assignments. In an example, a first assignment value may be calculated for the first responsibility assignments. A second assignment value may be calculated for the second responsibility assignments and the current delta may be calculated by dividing the first assignment value by the second assignment value.

At operation 435, it is determined (e.g., by the responsibility balancer 175, etc.) that the current delta is equal to the target responsibility delta. At operation 440, a user interface is generated (e.g., by the UI manager 145 as described in FIG. 1, etc.) to output the first responsibility assignments and the second responsibility assignments to a display device of a user computing device (e.g., the user computing device 105 as described in FIG. 1, etc.). The user interface includes a set of modification controls and each modification control is associated with a responsibility assignment of the first responsibility assignments and the second responsibility assignments.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensors. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document, for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for a social responsibility load balancer comprising:
at least one processor; and
memory comprising instructions that, when executed by the at least one processor, cause the at least one processor to perform operations to:
obtain first user data for a first user and second user data for a second user;
aggregate the first user data into a first dataset and the second user data into a second dataset;
evaluate the first dataset and the second dataset using a responsibility prediction learning model to determine a set of responsibilities;
calculate a target responsibility delta between first responsibility assignments for the first user and second responsibility assignments for the second user;
process the set of responsibilities using a responsibility balancing algorithm to sort the set of responsibilities into the first responsibility assignments and the second responsibility assignments;
calculate a current delta between the first responsibility assignments and the second responsibility assignments;
determine that the current delta is equal to the target responsibility delta; and
generate a user interface to output the first responsibility assignments and the second responsibility assignments to a display device of a user computing device, the user interface including a set of modification controls, each modification control associated with a responsibility assignment of the first responsibility assignments and the second responsibility assignments.

2. The system of claim 1, wherein the first user data is obtained from an external data source.

3. The system of claim 1, the memory further comprising instructions that, when executed by the at least one processor, cause the at least one processor to perform operations to:
train the responsibility prediction learning model by:
inputting a corpus of responsibility data and a corpus of user data into an artificial intelligence processor;
extracting responsibility features from the responsibility data and the user data; and
processing the responsibility features using a machine learning algorithm to generate the responsibility prediction learning model.

4. The system of claim 1, the instructions to calculate the target responsibility delta between the first responsibility assignments for the first user and the second responsibility assignments for the second user further comprising instructions that, when executed by the at least one processor, cause the at least one processor to perform operations to:
obtain a delta scale from a profile of the first user or the second user;
determine a delta value offset using the delta scale; and
apply the delta value offset to a standard delta value to calculate the target responsibility delta.

5. The system of claim 1, the instructions to calculate the current delta between the first responsibility assignments and the second responsibility assignments further comprising instructions that, when executed by the at least one processor, cause the at least one processor to perform operations to:
calculate a first assignment value for the first responsibility assignments; and
calculate a second assignment value for the second responsibility assignments, wherein the current delta is calculated by dividing the first assignment value by the second assignment value.

6. The system of claim 1, the instructions to process the set of responsibilities using the responsibility balancing algorithm to sort the set of responsibilities into the first responsibility assignments and the second responsibility assignments further comprising instructions that, when executed by the at least one processor, cause the at least one processor to perform operations to:
iteratively sort the set of responsibilities into the first responsibility assignments and the second responsibility assignments;
calculate an iterative delta for an iterative sort of the set of responsibilities into the first responsibility assignments and the second responsibility assignments;
compare the iterative delta to a previous delta;
determine that the iterative delta is closer to the target responsibility delta than the previous delta; and
perform another iterative sort of the set of responsibilities into the first responsibility assignments and the second responsibility assignments.

7. The system of claim 6, the memory further comprising instructions that, when executed by the at least one processor, cause the at least one processor to perform operations to:
determine that the iterative delta is not closer to the target responsibility delta than the previous delta;
set the previous delta as the current delta;
calculate a difference between the previous delta and the target responsibility delta;
adjust the target responsibility delta to the previous delta; and
output the difference in the user interface.

8. The system of claim 1, the memory further comprising instructions that, when executed by the at least one processor, cause the at least one processor to perform operations to:
identify a life event as output from an evaluation of the first dataset and the second dataset using a life event prediction learning model;
calculate a delta adjustment factor based on the life event; and
apply the delta adjustment to the target responsibility delta.

9. The system of claim 1, the memory further comprising instructions that, when executed by the at least one processor, cause the at least one processor to perform operations to:
evaluate the first dataset and the second dataset using a duplicate expense prediction learning model to identify a duplicate expense; and
output the duplicate expense to the user interface.

10. At least one non-transitory machine-readable medium including instructions for a social responsibility load balancer that, when executed by at least one processor, cause the at least one processor to perform operations to:
obtain first user data for a first user and second user data for a second user;
aggregate the first user data into a first dataset and the second user data into a second dataset;
evaluate the first dataset and the second dataset using a responsibility prediction learning model to determine a set of responsibilities;
calculate a target responsibility delta between first responsibility assignments for the first user and second responsibility assignments for the second user;
process the set of responsibilities using a responsibility balancing algorithm to sort the set of responsibilities into the first responsibility assignments and the second responsibility assignments;
calculate a current delta between the first responsibility assignments and the second responsibility assignments;
determine that the current delta is equal to the target responsibility delta; and
generate a user interface to output the first responsibility assignments and the second responsibility assignments to a display device of a user computing device, the user interface including a set of modification controls, each modification control associated with a responsibility assignment of the first responsibility assignments and the second responsibility assignments.

11. The at least one non-transitory machine-readable medium of claim 10, further comprising instructions that, when executed by the at least one processor, cause the at least one processor to perform operations to:
train the responsibility prediction learning model by:
inputting a corpus of responsibility data and a corpus of user data into an artificial intelligence processor;
extracting responsibility features from the responsibility data and the user data; and
processing the responsibility features using a machine learning algorithm to generate the responsibility prediction learning model.

12. The at least one non-transitory machine-readable medium of claim 10, the instructions to calculate the current delta between the first responsibility assignments and the second responsibility assignments further comprising instructions that, when executed by the at least one processor, cause the at least one processor to perform operations to:
calculate a first assignment value for the first responsibility assignments; and
calculate a second assignment value for the second responsibility assignments, wherein the current delta is calculated by dividing the first assignment value by the second assignment value.

13. The at least one non-transitory machine-readable medium of claim 10, the instructions to process the set of responsibilities using the responsibility balancing algorithm to sort the set of responsibilities into the first responsibility assignments and the second responsibility assignments further comprising instructions that, when executed by the at least one processor, cause the at least one processor to perform operations to:
iteratively sort the set of responsibilities into the first responsibility assignments and the second responsibility assignments;
calculate an iterative delta for an iterative sort of the set of responsibilities into the first responsibility assignments and the second responsibility assignments;
compare the iterative delta to a previous delta;
determine that the iterative delta is closer to the target responsibility delta than the previous delta; and
perform another iterative sort of the set of responsibilities into the first responsibility assignments and the second responsibility assignments.

14. The at least one non-transitory machine-readable medium of claim 13, further comprising instructions that, when executed by the at least one processor, cause the at least one processor to perform operations to:
determine that the iterative delta is not closer to the target responsibility delta than the previous delta;
set the previous delta as the current delta;
calculate a difference between the previous delta and the target responsibility delta;
adjust the target responsibility delta to the previous delta; and
output the difference in the user interface.

15. The at least one non-transitory machine-readable medium of claim 10, further comprising instructions that, when executed by the at least one processor, cause the at least one processor to perform operations to:
evaluate the first dataset and the second dataset using a duplicate expense prediction learning model to identify a duplicate expense; and
output the duplicate expense to the user interface.

16. A method for a social responsibility load balancer comprising:
obtaining first user data for a first user and second user data for a second user;
aggregating the first user data into a first dataset and the second user data into a second dataset;
evaluating the first dataset and the second dataset using a responsibility prediction learning model to determine a set of responsibilities;
calculating a target responsibility delta between first responsibility assignments for the first user and second responsibility assignments for the second user;
processing the set of responsibilities using a responsibility balancing algorithm to sort the set of responsibilities into the first responsibility assignments and the second responsibility assignments;
calculating a current delta between the first responsibility assignments and the second responsibility assignments;
determining that the current delta is equal to the target responsibility delta; and
generating a user interface to output the first responsibility assignments and the second responsibility assignments to a display device of a user computing device, the user interface including a set of modification controls, each modification control associated with a responsibility assignment of the first responsibility assignments and the second responsibility assignments.

17. The method of claim 16, further comprising:
training the responsibility prediction learning model by:
inputting a corpus of responsibility data and a corpus of user data into an artificial intelligence processor;
extracting responsibility features from the responsibility data and the user data; and
processing the responsibility features using a machine learning algorithm to generate the responsibility prediction learning model.

18. The method of claim 16, wherein calculating the current delta between the first responsibility assignments and the second responsibility assignments further comprises:
calculating a first assignment value for the first responsibility assignments; and
calculating a second assignment value for the second responsibility assignments, wherein the current delta is calculated by dividing the first assignment value by the second assignment value.

19. The method of claim 16, wherein processing the set of responsibilities using the responsibility balancing algorithm to sort the set of responsibilities into the first responsibility assignments and the second responsibility assignments further comprises:
iteratively sorting the set of responsibilities into the first responsibility assignments and the second responsibility assignments;
calculating an iterative delta for an iterative sort of the set of responsibilities into the first responsibility assignments and the second responsibility assignments;
comparing the iterative delta to a previous delta;
determining that the iterative delta is closer to the target responsibility delta than the previous delta; and
performing another iterative sort of the set of responsibilities into the first responsibility assignments and the second responsibility assignments.

20. The method of claim 19, further comprising:
determining that the iterative delta is not closer to the target responsibility delta than the previous delta;
setting the previous delta as the current delta;
calculating a difference between the previous delta and the target responsibility delta;
adjusting the target responsibility delta to the previous delta; and
outputting the difference in the user interface.
